(19) United States
(12) Patent Application Publication
(10) Pub. No.: US 2002/0079751 A1
(43) Pub. Date: Jun. 27, 2002

(54) Variable reluctance motor with reduced noise and vibration

(75) Inventors: Stanislaw Wladyslaw Janisiewicz, Endwell, NY (US); Darrin Michael Weiss, Vestal, NY (US); Andrew Zalesski, Apalachin, NY (US); Koen Alexander Gieskes, Binghamton, NY (US); Daniel J. Hibbard, Binghamton, NY (US)

Correspondence Address: BANNER & WITCOFF, 1001 G STREET N W, SUITE 1100, WASHINGTON, DC, 20001, US

(73) Assignee: Delaware Capital Formation, Inc., Wilmington, DE

(21) Appl. No.: 10/090,730

(22) Filed: Mar. 6, 2002

Related U.S. Application Data
(62) Division of application No. 09/820,769, filed on Mar. 30, 2001.
Application No. 09/820,769 is a continuation-in-part of application No. 09/538,528, filed on Mar. 30, 2000, now abandoned.

(51) Int. Cl. H02K 5/24; H02K 11/00

(52) U.S. Cl. 310/51; 310/68 R

(57) ABSTRACT

The present invention relates to a method and apparatus for reducing noise and vibration generated by a variable reluctance motor. The relative positions of paired opposing modules in each phase unit are adjusted relative to a stator, even after assembly of the motor, to reduce the noise and vibration.

### CROSS-REFERENCE TO RELATED APPLICATIONS

This application is a divisional of U.S. patent application Ser. No. 09/820,769, filed Mar. 30, 2001, which is a continuation-in-part of U.S. patent application Ser. No. 09/538,528, filed Mar. 30, 2000, filed Sep. 8, 1999, now abandoned, the entire contents of which are incorporated herein by reference.

### FIELD OF THE INVENTION

The present invention relates to a method and apparatus for reducing the level of noise produced by a variable reluctance motor. More particularly, the present invention relates to a variable reluctance motor having air gaps on opposite sides of a stator that are adjusted to reduce the level of noise created during the operation of the motor.

### BACKGROUND OF THE INVENTION

Variable reluctance motors are used as direct drive motors for machines that perform repeated applications requiring a high degree of accuracy. These motors include phase assemblies and elongated stators that control the movement of tools such as robotic arms and placement heads along a first axis and a second axis. During the operation of some conventional pick-and-place machines, the phase assemblies and stators move relative to each other via electromagnetic propulsion. The relative movement between each phase assembly and its stator causes the robotic arm or placement head to move from a first position to a second position. However, this position-to-position movement must be completed with a high degree of precision and at a high velocity under varying load conditions.

Excessive audible noise is a drawback to many variable reluctance motors. This excessive noise is generated during the relative movement between the phase assemblies and the stators. Numerous attempts have been made in the prior art to reduce the decibel levels of this audible noise. These include adjusting the frequency, application time and/or magnitude of an electrical current applied to each phase assembly. However, these attempts have not been successful for one reason or another. For example, at the high speeds that many of these machines achieve during their operation, there is no time for multiple pulses to be applied to the components of a particular phase assembly. As a result, pulse width modulation is not an effective solution.

Attempts have also been made to reduce the noise by improving the manufacturing accuracy of the motors. In general, previous variable reluctance motors have attempted to prevent the excessive noise by designing, manufacturing and assembling variable reluctance motors as accurately as possible. However, it has been found that even with great care, it is difficult to reliably reduce noise and vibration to the levels desired during actual use. In addition, manufacturing the components of these motors within the small tolerances that were believed to eliminate the excessive noise is very expensive. Moreover, it is only after the motor has been assembled and used that the level of noise and vibration produced are determined. Therefore, a manufacturer may have spent a large sum of money and manufacturing time only to arrive at a motor that does not operate with reduced noise levels.

### SUMMARY OF THE INVENTION

To overcome the drawbacks of the prior art, the present invention includes a variable reluctance motor comprising a phase assembly including first and second phase modules. The first phase module is positioned opposite to and spaced apart from the second phase module. The motor also comprises a stator that extends between the first and second phase modules such that air gaps are formed between the stator and each phase module. The motor further includes at least one positioning system. The positioning system is configured to adjust the size of the gaps in order to adjust the level of noise produced by the motor.

### BRIEF DESCRIPTION OF THE FIGURES

FIG. 1 is an isometric view of a variable reluctance linear motor with top plate removed, including a modular phase assembly according to the present invention;

FIG. 2 is a partial exploded isometric view of the phase assembly shown in FIG. 1;

FIG. 3 is a planar view of opposing C-core laminations of a phase unit between which a stator lamination is interposed in the motor of FIG. 1;

FIG. 4 is an isometric view of a phase module of a phase unit in the assembly of FIG. 1;

FIG. 5 is a partially exploded isometric view of the phase assembly of FIG. 1;

FIG. 6 is an isometric view of the stator shown in FIG. 1;

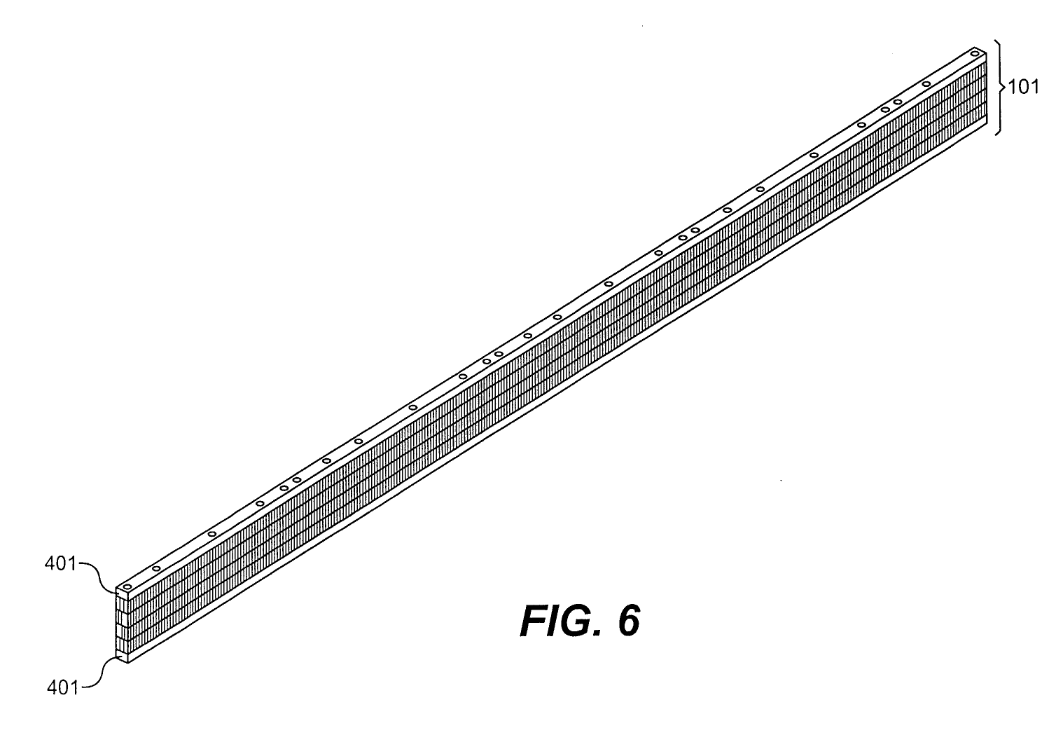

FIG. 7 is a planar view of a phase unit in the variable reluctance motor of FIG. 1;

FIG. 8 is a cross sectional view of the variable reluctance motor of FIG. 1;

FIG. 9 shows a voltage waveform, applied to the motor phase coils, that is used for motor balancing; and

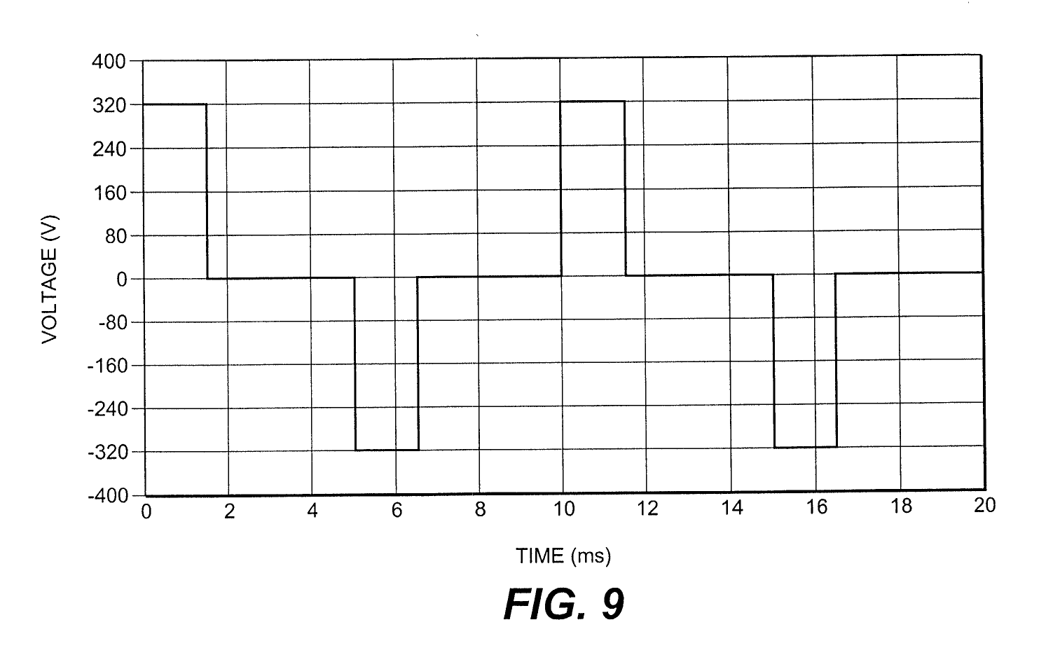

FIGS. 10A and 10B illustrate the compliant shaft according to the present invention.

### DETAILED DESCRIPTION OF THE FIGURES

It has been found that one of the sources of elevated motor noise lies in the unbalance of the internal motor forces. The present invention therefore relates to a method and apparatus for adjusting the gap in each of the motor phase units and thus reducing the noise of the variable reluctance motor.

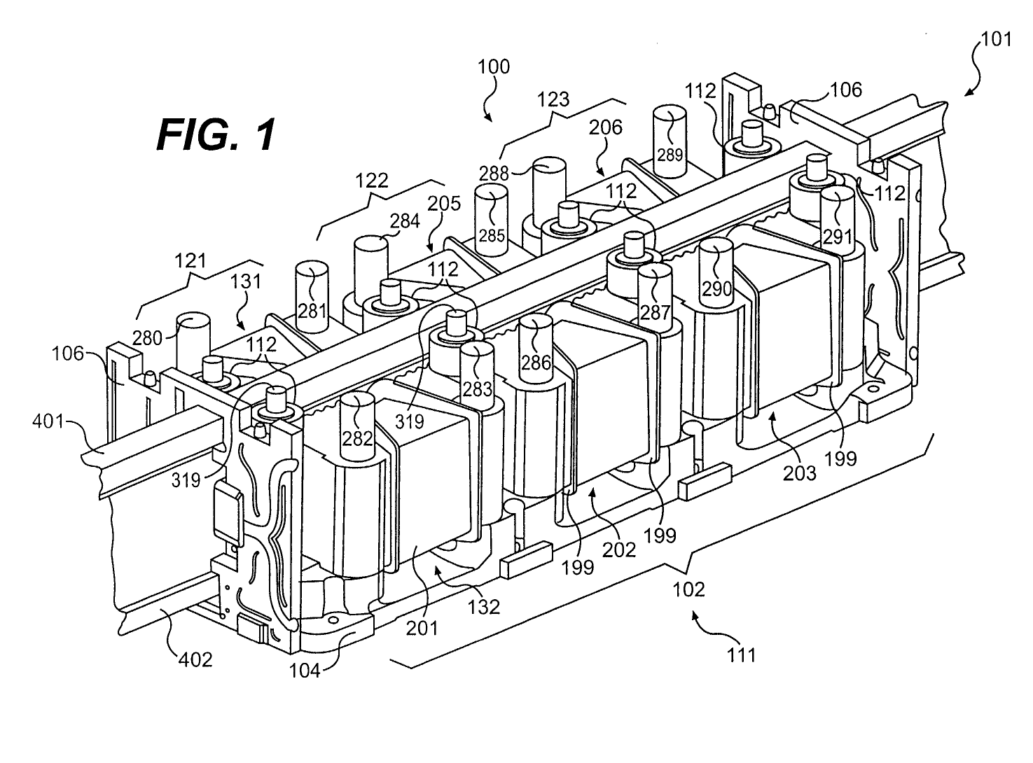

FIG. 1 illustrates a motor 100 that includes a stator (stator bar) 101. In one embodiment, the motor 100 is a linear variable reluctance motor used with a machine that receives and positions components on a substrate. Such machines are commonly referred to as “pick-and-place machines” and are disclosed in U.S. Pat. Nos. 5,852,869 and 5,649,356. Although the present invention is described with respect to a pick and place machine, its use is not limited only to these machines. Instead, in alternative embodiments, the motor 100 is used with other machines that require high force movements that must be completed with a high degree of accuracy. Additionally, in one embodiment, the motor 100 is a linear, variable reluctance motor that comprises at least one phase unit as discussed below.

In addition to stator 101, the motor 100 also comprises an armature 111 that moves relative to the stator along a predetermined path of motion. In one embodiment, the armature 111 is a linearly slidable portion that includes a phase assembly 102, as discussed below. Alternatively, in another embodiment of the variable reluctance motor, the armature is a rotary assembly.

In an embodiment illustrated in FIG. 1, the armature 111 includes a slidable phase assembly 102 that moves relative to the stator 101 in response to the application of a generated force. In FIG. 1, the stator 101 is fixed in position and the phase assembly 102 moves along the length of the stator 101 in a direction parallel to a first axis during the operation of the motor 100. In an alternative embodiment, the phase assembly 102 moves along the stator 101 in a second axis. When motion is required along both the first axis and the second axis, the machine (not shown) includes a first phase assembly that moves relative to a first stator in a direction parallel to the first axis and a second phase assembly moves relative to a second stator in a direction that extends parallel to the second axis.

In a first embodiment, the phase assembly 102 comprises three phase units 121-123. However, in a second embodiment, the phase assembly 102 includes only two phase units. In other alternative embodiments, the motor 100 includes between four and seven phase units. Still other embodiments include more than seven phase units, the maximum number of phase units being limited by size and cost considerations.

Each phase unit 121-123 comprises two opposing paired phase modules 131, 132; 205, 202; 206, 203, respectively. These phase modules are substantially identical and secured to base and top housing plates 104, 105 in substantially mirror image positions so that a fixed distance extends between the paired phase modules. The stator 101 and air gaps 812, 813 separate the opposing phase modules 131, 132; 205, 202; 206, 203 of each phase unit 121-123 from each other. The phase modules each comprise a core 201 of stacked core phase modules or laminations 250 having teeth 150 and flux funnel grooves 160.

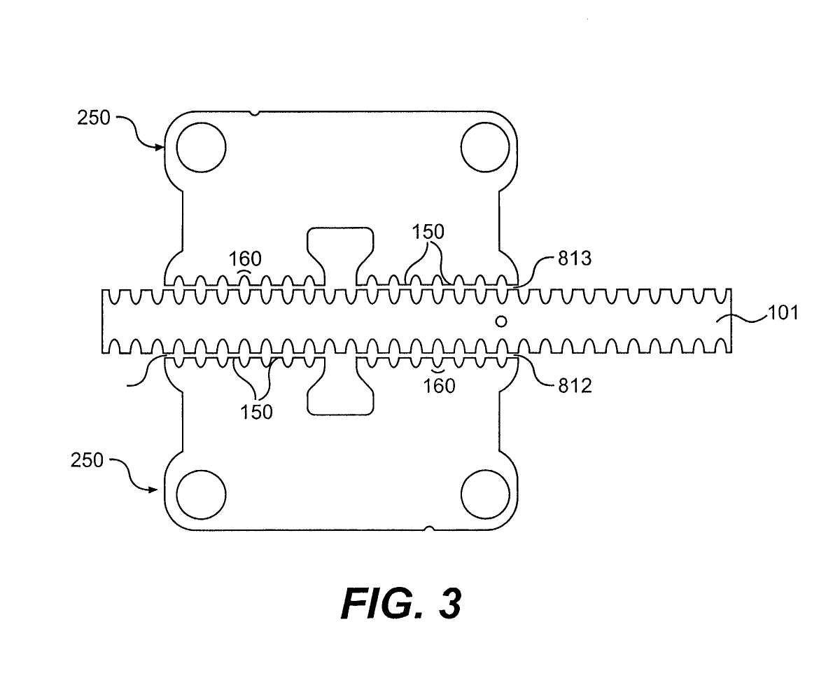

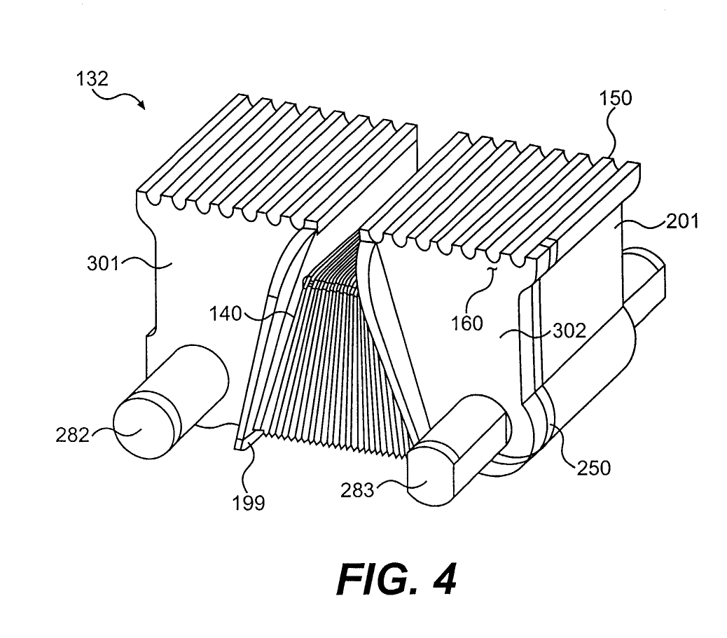

The core stack 201 has a substantially C shape and comprises a plurality of C-core laminations 250 as shown in FIGS. 3 and 4. Additionally, each phase module includes a pair of shafts 280-291, a bobbin 180 and a wire coil 140 having at least one winding around the bobbin 180. The number of windings changes depending upon the amount of flux that is needed. In one embodiment, the bobbin 180 is formed of a non-conductive material. One such non-conductive material is a plastic.

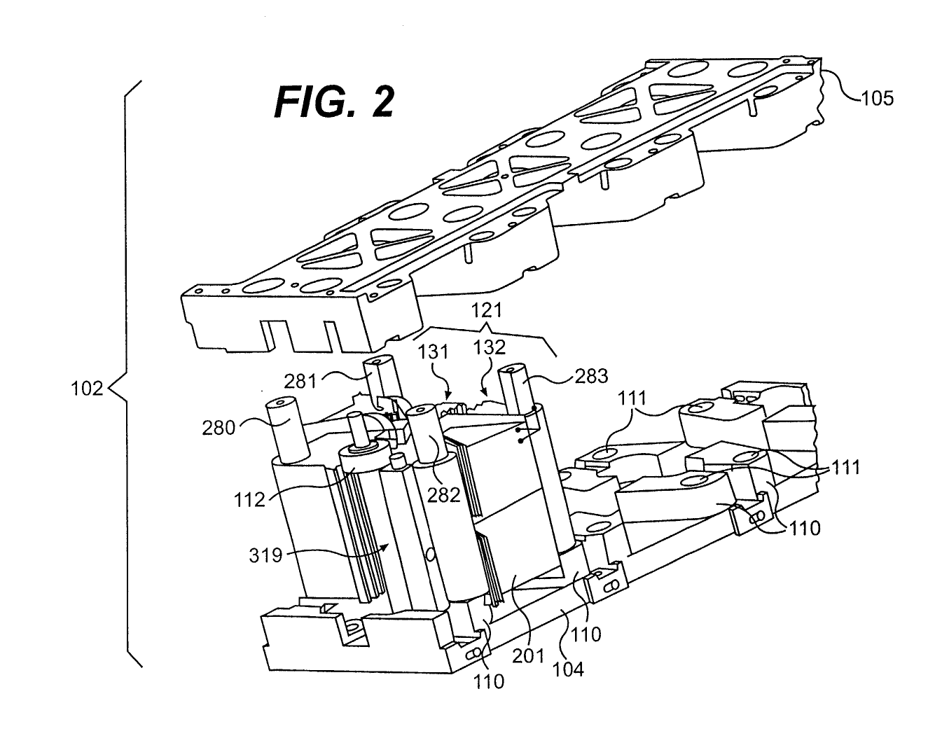

As shown in FIG. 2, each boss 110 in the base and top plates 104, 105 includes a plurality of wells 111 for receiving and securely retaining a pair of shafts 280-291 that extend through and outwardly from each stack 201 of C-core laminations 250 for each phase module. In one embodiment, each phase module is retained in the plates 104, 105 by press fitting its respective shafts 280-291 into the wells 111 of the base plate 104 and the top plate 105. In an alternative embodiment, the phase modules are adhered to the base plate 104 and the top plate 105 using a non-conductive epoxy. In yet another embodiment, the phase modules are secured to the base plate 104 and top plate 105 by threaded fasteners. In one embodiment, the threaded fasteners include bolts. In a second embodiment, the threaded fasteners include screws. The base and the top plates 104, 105 are configured to provide fixed locations for placement of phase modules and stator guide bearings 112.

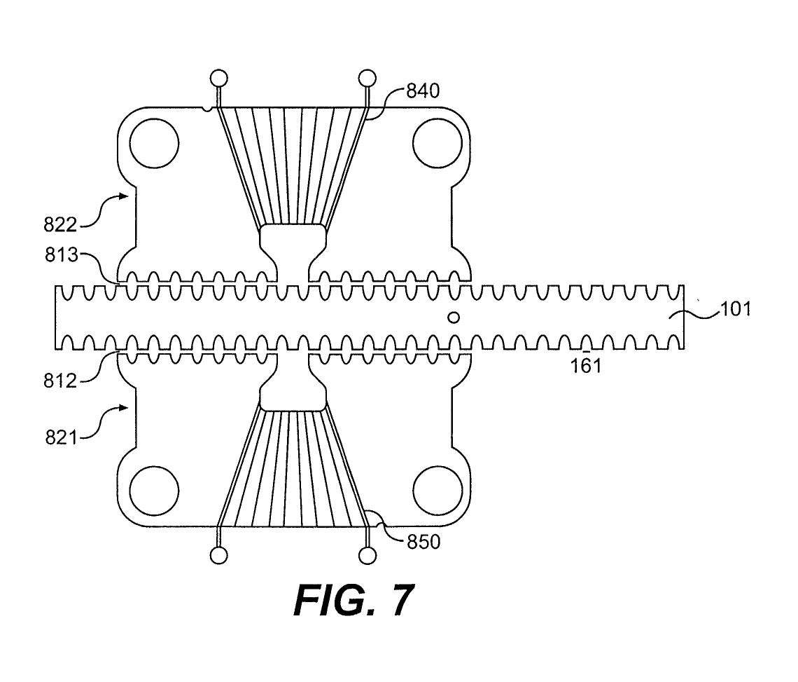

As shown in FIG. 1, the stator 101 is positioned within its respective phase assembly 102 between the paired phase modules by at least one set of stator positioning members 112. In the illustrated embodiment, the stator positioning members comprise stator guide bearings 112 that contact and apply a locating pressure to the first and second rails 401, 402 of the stator 101. The stator guide bearings 112 rotate relative to their respective phase assembly 102 as the stator 101 and modular phase assembly 102 move relative to each other during the operation of the motor 100. As discussed below, the stator guide bearings 112 adjust the location of the stator 101 so that air gaps 812, 813, shown in FIG. 7, are formed on either side of the stator 101. As seen in FIG. 3, each air gap 812, 813 extends between the stator 101 and one of the phase modules. In one embodiment, the air gaps 812, 813 have the same size.

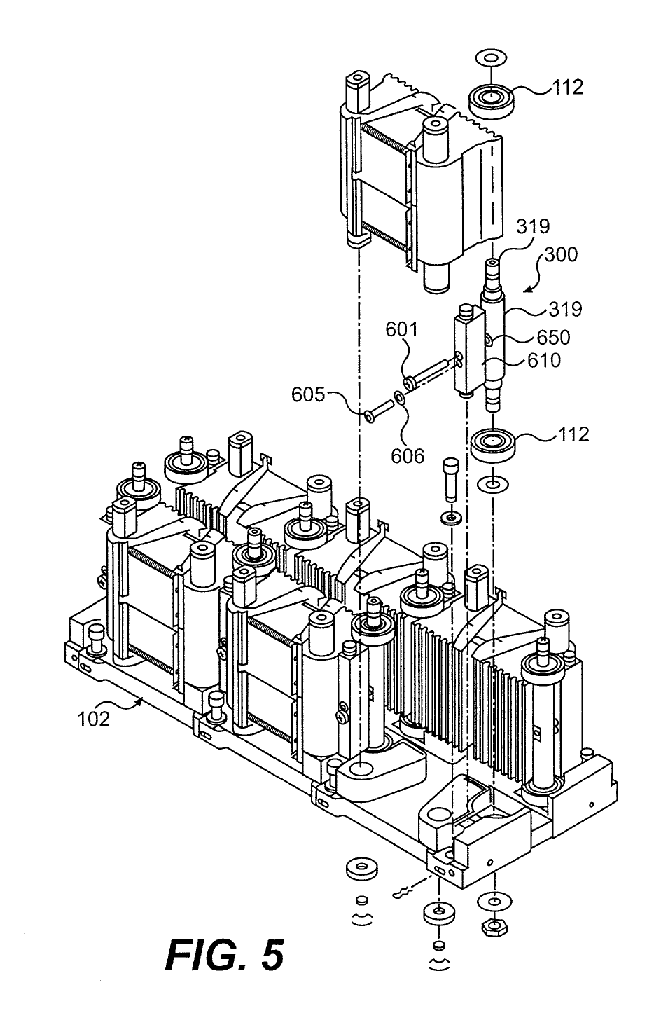

A shaft 319 extends between each pair of cooperating guide bearings 112. Each shaft 319 is secured to base and top housing plates 104, 105 so that each guide bearing 112 is securely held against movement in a direction parallel to the length of shaft 319. As seen in FIG. 5, each guide bearing 112 is securely positioned in a preformed boss 110 in the base housing plate 104 and/or the top housing plate 105. In one embodiment, each guide bearing includes a known ball bearing arrangement. Each boss 110 is integrally formed with its respective housing plate 104, 105. The designations “top” and “bottom” are for reference purposes only and are not intended to be limiting on the position of the housing plates or the orientation of the phase assembly 102.

As shown in FIG. 2, the base and top housing plates 104, 105 are in planes that extend parallel to each other and comprise the housing of the modular phase assembly 102. End pieces 106, as shown in FIG. 1, are attached to the base housing plate 104 and the top housing plate 105. In one embodiment, the end pieces 106 include oil-saturated felt wipers (not shown) that lubricate the rails 401, 402 of the stator 101 for low friction rolling engagement with stator guide bearings 112. In another embodiment, the end pieces 106 support a motion brake sensor of the type described in U.S. Pat. No. 5,828,195 and entitled “Electronic Brake for a Variable Reluctance Motor.”

In order to reduce noise, the position of each phase module 131, 132; 205, 202; 206, 203 is adjusted relative to the stator 101. It has been found that this adjustment reduces the amount of vibration and acoustic created during the operation of the variable reluctance motor.

The relative position of the stator 101 to each phase module of a pair of phase modules is adjusted by positioning system 300, as illustrated in FIG. 5. For ease of explanation, the positioning system 300 will be explained in combination with only one set of paired, opposing phase modules 131 and 132. However, this discussion is also applicable to the positioning systems 300 used with each set of paired, opposing phase modules within the motor 100.

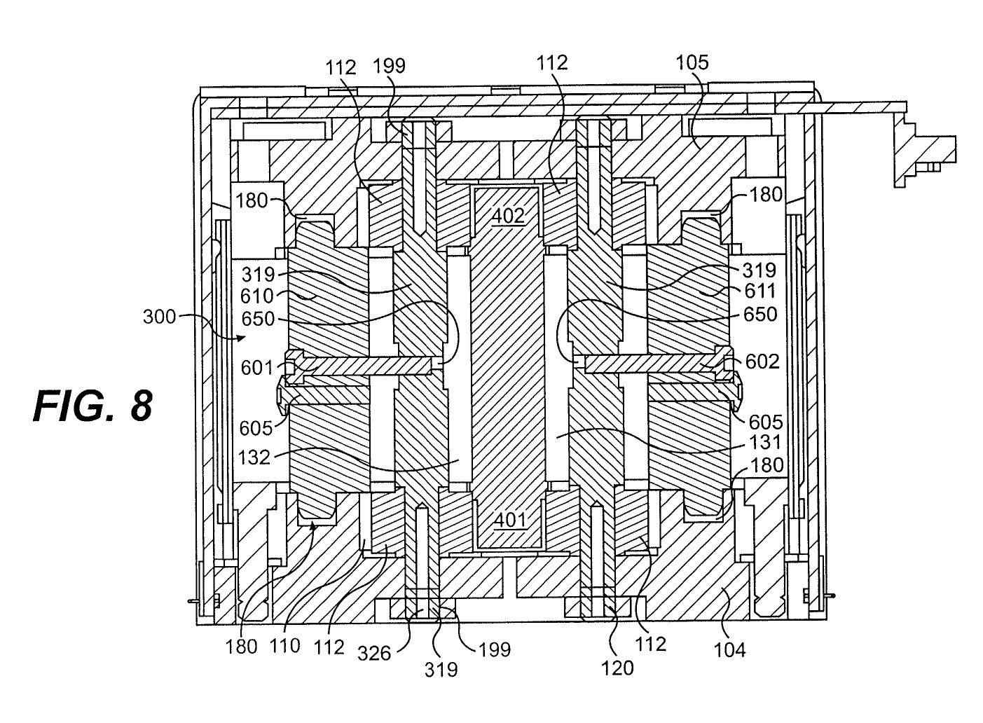

As shown in FIGS. 5 and 8, each phase module 131, 132 includes its own positioning system 300. In an alternative embodiment, only one of these phase modules includes a positioning system 300. As a result, the singular positioning system 300 would be located only on one side of the stator 101. In this alternative embodiment, the next, adjacent phase unit also includes only one positioning system 300. However, the adjacent positioning system 300 is positioned on the opposite side of the stator 101 from the first positioning system 300.

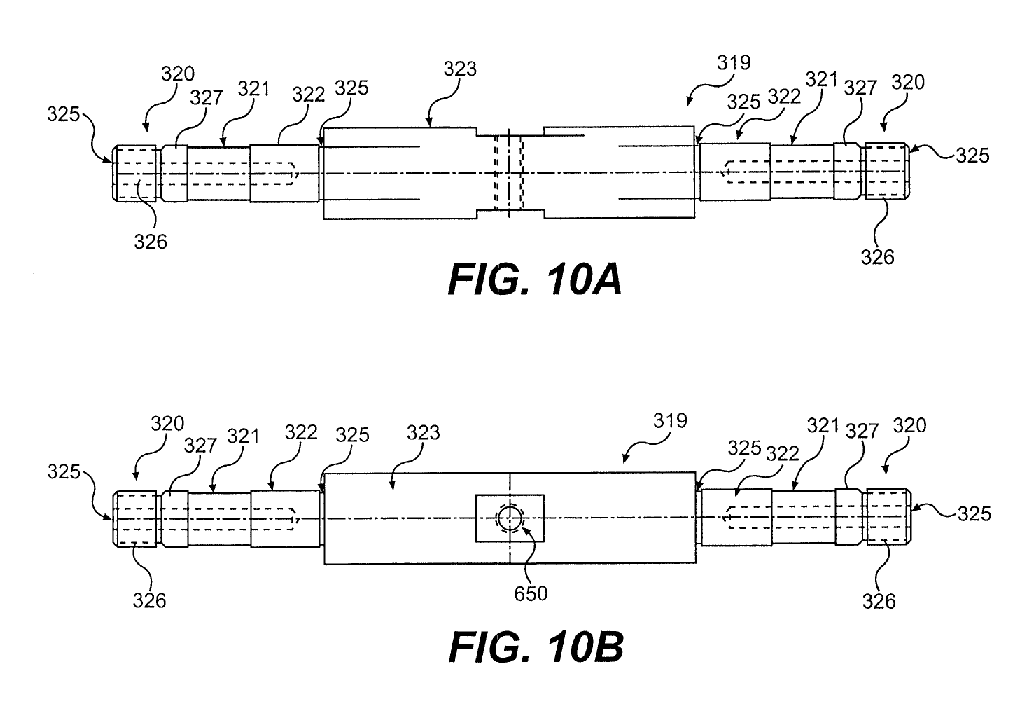

Each positioning system 300 includes the compliant shaft 319 that extends axially through the center of stator guide bearings 112 and is received in housing plates 104, 105. In one embodiment of the invention, the compliant shaft is formed of a stainless steel. In an alternative embodiment, the positioning systems 300 each include a pair of shafts 319 that extend through respective stator guide bearings 112. Each compliant shaft 319 includes seven sections 320-323 as seen in FIGS. 10A and 10B that permit it to be flexed under pressure, even when its ends are held in a stationary position. The first and seventh sections 320 form the ends 325 of each shaft 319. Both ends 325 include an inwardly, axially extending screw 326 and a press fit cap 327. The sections 321 inside each press fit cap 327 have a slightly smaller diameter than the press fit cap 327 and the bearing section 322. The diameter of each section 321 is between about five mils and three mils smaller than the diameter of sections 320 and bearing sections 322. Bearing section 322 is located just to the inside of section 321. The bearings 112 are positioned and secured in bearing section 322. In one embodiment, the bearings 112 are slip fit on the bearing sections 322. A neck 325 having a diameter that is substantially the same size as section 321 and smaller than the diameter of section 322 extends from the bearing section 322 to the center section 323. Along with the materials used for shaft 319, the reduced diameter of sections 321 and neck 325 permit the shaft 319 to flex in the direction of the stator 101 so that the bearings 112 apply a force to the stator 101 and move it relative to the C-core stacks 201. As discussed below, the center section 323 includes a threaded bore 650 for receiving a threaded screw 601 that creates the force that flexes the sections of shaft 319 in order to adjust the size of the air gaps 812, 813 between the stator 101 and the C-core stacks 201.

The bearing shafts 319 are fixed in a substantially equal relative position to the C-cores of phase modules 131, 132 in order to initially establish equal sized air gaps between the stator 101 and the stacks 201 of the phase modules 131, 132 when the motor 100 is assembled. However, due to the tolerances associated with the fabrication and assembly process of the motor 100, a dynamic unbalance of the internal forces between the stator and its related phase modules is present and the vibration and noise of the motor will be unnecessarily high when the motor 100 is operated.

The size of each air gap 812, 813 is adjusted, in other words, fine tuned, by positioning system 300 after the motor 100 has been fully assembled in order to reduce the level of noise produced. This is accomplished by repositioning the stator 101. The shape of the compliant shaft 319 and its flexible nature assures that a controlled preload is provided for positioning the bearing 112 against the stator 101 so that the bearings 112 are forced into contact with the rails 401, 402 after the motor has been assembled. In one embodiment, the stator guide bearings 112 are conventional ball bearings that include a portion that rotates around the compliant shaft 319. The compliant shaft 319 is fitted into a preformed compliant shaft well 199.

As illustrated in FIG. 5, the positioning system 300 also includes an adjustment screw 601. The screw 601 is threadably received in and extends through a stationary reference plate 610, 611 that is secured to plates 104, 105. Base housing plate 104 and top housing plate 105 have preformed reference plate wells 180 for receiving the stationary reference plates 610, 611 and preventing any relative movement between the plates 610, 611 and the plates 104, 105. For the clarity of the explanation, only plate 610 will be discussed. However, this discussion is equally applicable to plate 611.

As mentioned above, adjustment screw 601 is used to change the relative size of the air gaps 812, 813 between the stator 101 and the phase modules. The threaded end of screw 601 is received in a threaded bore 650 in compliant shaft 319. Adjustment screw 601 is held in place by an associated holding screw 605 and washer 606 that overlap the recessed head of screw 601. When the screw 601 is rotated so that the shaft 319 moves in a direction away from the stator 101, the pressure applied by the guide bearings 112 is released and the stator 101 moves in the direction of the phase module containing the rotated screw 601.

In an alternative embodiment, the distance between each phase module and the stator 101 is adjusted by sliding each core stack 201 along the plates 104, 105. This arrangement permits the adjustment of the distance between each individual stack 201 and the stator 101 so that the desired sized air gaps 812, 813 are formed. In another embodiment, the entire modular phase assembly 102 is slidably mounted to the plates 104, 105 so that it laterally shifts relative to the stator 101 in a direction perpendicular to the length of the stator 101 when the air gap sizes are adjusted.

Another alternative embodiment for adjusting the air gaps 812, 813 between each C-core stack 201 and the stator 101 includes sliding the shaft 319 relative to the stator 101 and the plates 104, 105. In this embodiment, the block 610 or shaft 319 slides along the plates 104, 105 in the direction of the stator 101 or away from the stator 101. This is accomplished by advancing or retracting the screw 601 through a threaded bore in the block 610.

Methods for reducing the noise created by motor 100 are discussed below. One method includes a first step of applying an AC current to only one of the phase units and measuring the noise level using conventional noise meters. Second, a mechanical adjustment is made to move the stator 101 by turning screw(s) 601 to a position at which the noise generated by the motor phase unit approaches a minimum. The lowest achievable noise level will differ from motor to motor. Third, the above steps are performed for every phase unit in the motor.

Fourth, the above steps are performed again for all phase units until every phase unit is adjusted and no further adjustment is deemed necessary. This step is performed because an adjustment to a later adjusted phase unit may affect the alignment that was already achieved for a previously adjusted phase unit.

Another method for reducing noise levels includes measuring the inductances within the phase assembly. The relative positions of the phase modules to the stator 101 in each phase unit are then adjusted as discussed above until the inductances in each coil 140 on opposing phase modules are balanced. The optimum position of the stator 101 is achieved when the inductance of the coil 140 on one side of the stator is the same as the inductance of the coil 140 on the opposite side of the stator for the same phase unit.

In addition to measuring the noise level or inductance of the coils of each phase module, methods for reducing acoustic noise and vibration include, without being exhaustive, physically measuring the size of the air gap between a phase module and a stator and comparing that measurement with that of the other air gap of the opposing phase module in the same phase unit. In a first embodiment, the size (distance) of the air gaps is measured using optical measuring equipment. In an alternative embodiment, mechanical measuring equipment is used. The measurements are then compared to detect a gap size imbalance that will produce noise and vibration during use. However, measuring the air gaps is not as effective or as efficient as measuring the noise or determining the inductance of opposed phase modules, as discussed above.

While the above description contains many specifics, these should not be construed as limitations on the scope of the invention, but rather as an exemplification of one preferred embodiment thereof. Other variations are possible. Accordingly, the scope of the present invention should be determined not by the embodiments illustrated above, but by the appended claims and their legal equivalents.

We claim:

1. A method of reducing the level of noise created by a variable reluctance motor during operation, said method comprising the steps of:
providing an electrical current to a pair of phase modules of a first phase unit, one of said phase modules being on an opposite side of a stator from the other phase modules and forming part of an opposing phase module;
determining if the distance between each phase module and the stator is equal; and, if necessary,
adjusting the distance between each phase module and the stator until the distances are equal.

2. The method of reducing the level of noise created by a variable reluctance motor according to claim 1 wherein the steps of claim 1 are repeated for further including the step of applying an electrical current to a pair of coils of a second phase unit spaced from said first phase unit.

3. The method of reducing the level of noise created by a variable reluctance motor according to claim 1 wherein said determining step includes the step of measuring the noise level of the motor.

4. The method of reducing the level of noise created by a variable reluctance motor according to claim 2 wherein said adjusting step includes the step of changing a position of a plurality of positioning phase modules in contact with said stator.

5. The method of reducing the level of noise created by a variable reluctance motor according to claim 4 wherein said changing step includes advancing a threaded member into a shaft carrying at least a pair of said positioning phase modules.

6. A method of adjusting a variable reluctance motor in order to reduce a level of noise generated by said motor, said method comprising the steps of:
measuring an inductance of each of a pair of opposing coils in a phase unit of the motor; and
mechanically adjusting a distance between each phase module of said phase units and a stator positioned between said phase modules to achieve the same inductance in each of said coils.
